(19) United States
(12) Patent Application Publication
(10) Pub. No.: US 2008/0236931 A1
(43) Pub. Date: Oct. 2, 2008

(54) HYDRAULIC STEERING SYSTEM

(75) Inventors: Stephen Crow, Ames, IA (US); Kjeld Buus Jensen, Soenderborg (DK); Preben Albrecht, Soenderborg (DK); John Kristensen, Soenderborg (DK)

Correspondence Address: MCCORMICK, PAULDING & HUBER LLP, CITY PLACE II, 185 ASYLUM STREET, HARTFORD, CT, 06103, US

(73) Assignee: SAUER-DANFOSS APS, Nordborg (DK)

(21) Appl. No.: 12/027,450

(22) Filed: Feb. 7, 2008

(30) Foreign Application Priority Data
Feb. 8, 2007 (DK) PA 2007 00213

(51) Int. Cl. B62D 5/065

(52) U.S. Cl. 180/422

(57) ABSTRACT

The invention provides a steering system e.g. for a vehicle. The system comprises a system-pump, a steering actuator, a rotary valve, a rotary meter, and a motor. The system-pump is arranged to provide a flow of a fluid to the steering actuator via the rotary valve and via the rotary meter, and the motor is arranged to provide rotation of the rotary valve and the rotary meter. To handle an emergency situation if the system-pump fails, the motor is dimensioned to operate the rotary meter as a fail-operational pump for pumping a flow of the fluid to the steering actuator if the system-pump fails.

### CROSS REFERENCE TO RELATED APPLICATION

Applicant hereby claims foreign priority benefits under U.S.C. § 119 from Danish Patent Application No. PA 2007 00213 filed on Feb. 8, 2007, the contents of which are incorporated by reference herein.

1. Technical Field

The invention relates to a hydraulic steering system e.g. for a vehicle.

2. Background of the Invention

Steering systems of the above-mentioned kind can be used in applications including two-or four-wheel steering for vehicles, rudder steering for ships. Vehicles, and in particular off-highway machinery such as wheel loaders, excavators, dozers, tractors, harvesters and similar heavy duty machines often operate with hydraulic steering systems. Typically, the steering system receives a desired steering input to indicate a desired angular movement of the vehicle. The steering could be manual by a steering handle, automatic e.g. by use of a sensor, and it could be remote-controlled e.g. via satellite.

The steering system often comprises a steering unit with a rotary valve and a rotary meter. The steering unit is typically connected mechanically to a steering wheel of the vehicle. When the steering wheel is turned, a steering fluid, e.g. oil, is directed from the steering system-pump via the rotary valve and rotary meter to the cylinder ports L or R, depending on the direction of the turn. The rotary meter meters the oil flow to the steering cylinder in proportion to the angular rotation of the steering wheel. The steering cylinder is mechanically connected to the steering element, typically the front wheels of the vehicle. If the oil supply from the steering pump fails or is too small, the rotary meter is able to work as a manual steering pump. In this case, the steering fluid is sucked from a reservoir and pumped to the steering cylinder based on the manual rotation of the steering wheel. Steering units are disclosed e.g. in U.S. Pat. No. 5,992,458 and in U.S. Pat. No. 5,638,864.

The rotary valve has a neutral configuration and two operating configurations on opposite sides of neutral. In operation, the rotary valve is moved relative to a valve housing. Due to resistance in the steering system, the rotational movement of the rotary valve member relative to the housing also results in movement of the valve member from the neutral configuration to one of the operating configurations whereby a fluid path is opened from the system-pump via the rotary meter to the steering actuator.

To control the extent of the displacement of the steered element, the rotary meter meters out the amount of fluid which is actually delivered from the system-pump to the steering actuator. The rotary meter comprises chambers which, during rotation of the rotary valve and the rotary meter, expand and contract and thereby meter the fluid which flows between the system-pump and the steering actuator.

As aforementioned, the rotary meter may be used as a manually operated steering pump if the oil supply from the steering pump fails or is too small. In this case, the operator typically uses the steering wheel as a handle for rotating the rotary meter, and inevitably, this increases the steering wheel resistance significantly.

### SUMMARY OF THE INVENTION

It is an object of embodiments of the present invention to provide a steering system with improved fail-operation possibilities. According to a first aspect, this is achieved by a system in which the motor is dimensioned to operate the rotary meter as a pump for pumping a flow of the fluid to the steering actuator at a pressure which is sufficient for moving the actuator if the system-pump fails.

Since the motor is dimensioned to keep the steering pressure via the rotary meter when the meter is operated as a system pump, the steering system becomes fail-operational in case of system pump failures.

Due to the increased safety, the steering system according to the invention is advantageous e.g. in combination with a Steer-By-Wire steering application.

The rotary valve could have a sleeve with a bore and an internally rotating spool. Both the sleeve and the spool could be rotationally suspended in a valve housing, and rotation could be effected via a spindle which extends out of the housing. In one common type of valve, the spool is connected to the spindle and to the sleeve. When the spindle is rotated, the spool rotates, and via a spring, the spool rotates the sleeve. The rotary valve and the rotary meter may be combined in a steering unit e.g. of the kind which is well known in the art. In such units, the rotary valve and the rotary meter may be operated by one common spindle or rotary shaft so that they rotate with equal speed.

The motor could be of any kind, e.g. an AC electrical motor with a variable speed control, or a DC motor of the kind which is regularly used for various purposes in vehicles. Since such motors tend to be less expensive when they perform optimally at large RPM (rounds per minute), a transmission with a gear ratio may be inserted between the motor and the rotary valve and rotary meter so that the motor spindle rotates faster than the rotary valve and rotary meter spindles. Preferably, the motor is a variable RPM electric motor. To increase the safety further, the motor may comprise several independent or partly independent motor systems, e.g. several independent motors in parallel or serial connection or motor(s) with several independent sets of windings, or motor(s) having independent electrical power supplies. In that way, a motor failure becomes less critical since failure of one of the systems merely reduces the maximum available motor power.

To enable steering of the vehicle via electronic input means such as via GPS navigation means, joystick, auto-steering means etc. the motor may be controlled by a control system. The control system could be adapted to operate the motor to rotate the rotary meter and the rotary valve to provide a fluid flow to the steering actuator which corresponds to a steering input which is received from the joystick, auto-steering etc.

To enhance fail-operational characteristics of the system, the motor device could comprise multiple torque devices, either housed together or separately, to ensure torque generation capability at all times.

The typical relationship between spool size and rotary meter displacement could be changed relative to those normally selected for manual steering in traditional systems. This will allow the motor to operate at higher RPMs and lower torque levels than conventional systems. In one embodiment, the steering system is designed so that the rotary meter provides an adequate amount of fluid at a suitable pressure when the motor rotates at 500-3000 RPM. In one embodiment, this is achieved by inserting a gear ratio between 2:1 and 20:1 between the motor and the rotary meter, and in another embodiment, the rotary meter is driven directly by the motor without any gear ratio. In case of the latter, the rotary meter is designed to provide an adequate flow and pressure and an RPM which is suitable for the motor, e.g. between 500 and 3000 RPM.

The motor may rotate the rotary meter at a maximum RPM, at which RPM the rotary meter provides a fluid flow which is at least 50 pct of a maximum capacity of the system-pump. I.e. when the motor rotates at its maximum speed/torque ratio, the steering actuator can be moved at a speed of at least 50 of the speed which is obtainable by use of the system-pump, when the system pump is operational.

In a second aspect, the invention provides a method of operating a steering system in a fail situation, the steering system comprising a system-pump, a steering actuator, a rotary valve, a rotary meter, and a motor, the method comprising:
arranging the system-pump to provide a flow of a fluid to the steering actuator via the rotary valve and via the rotary meter,
arranging the motor to provide rotation of the rotary valve and the rotary meter, and
operating the rotary meter as a pump for pumping a flow of the fluid to the steering actuator by use of the motor in case the system-pump fails.

In a third aspect, the invention provides a vehicle with a steering system comprising a system-pump, a steering actuator, a rotary valve, a rotary meter, and a motor, the system-pump being arranged to provide a flow of a fluid to the steering actuator via the rotary valve and via the rotary meter, and the motor being arranged to provide rotation of the rotary valve and the rotary meter, characterized in that the motor is dimensioned to operate the rotary meter as a pump for pumping a flow of the fluid to the steering actuator if the system-pump fails.

In one embodiment, the vehicle is steered by rotation of a steering element, e.g. by rotation of front wheels etc. The rotation is initiated by a steering-torque provided by the steering actuator onto the steering element.

To further increase safety, the vehicle may comprise two independent electrical systems, one providing power to the system-pump and one providing power to the motor. Alternatively, the system-pump could be driven by the main engine of the vehicle, e.g. via a belt-transmission, and the motor which drives the rotary valve and rotary meter could be driven by electrical power provided from a battery and/or a generator driven by the engine.

The method and vehicle may comprise further features as described relative to the first aspect of the invention.

### BRIEF DESCRIPTION OF THE DRAWINGS

In the following, preferred embodiments of the invention will be described in further details with reference to the drawing in which:

FIG. 1 illustrates schematically a steering system according to the invention, and

FIG. 2 illustrates in graph, ratios between RPM and torque for a motor used in a steering system according to the invention.

### DESCRIPTION OF PREFERRED EMBODIMENTS

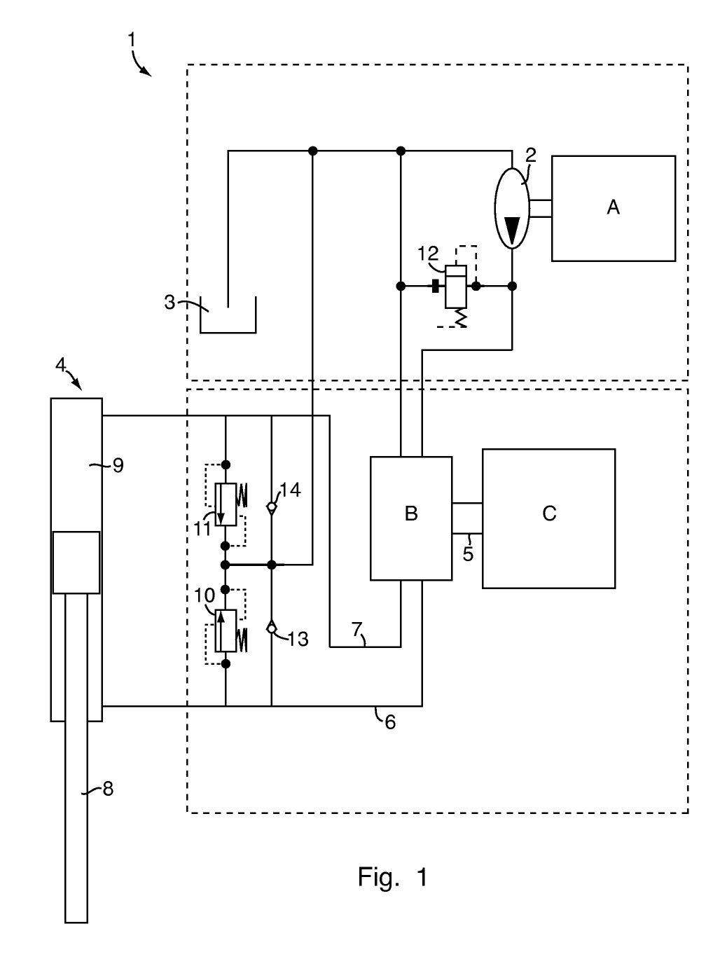

As shown in FIG. 1 a steering system 1 according to the invention comprises a system-pump 2, connected to a reservoir 3 from which a fluid is pumped to the steering actuator 4. The steering actuator may e.g. rotate front wheels, a rudder etc. depending on the application of the steering system. The system-pump is driven by a 1500 watt electric motor A, and the outlet of the pump is connected to a steering unit B. The system-pump could also be driven by a main engine of the vehicle, e.g. by a diesel engine via a belt-drive. In addition to, or as an alternative to the illustrated system-pump, the system may comprise another system-pump, e.g. an emergency system-pump, e.g. a pump which is driven by the wheels of the vehicle. The steering unit B comprises a rotary valve and a rotary meter driven by one common drive shaft 5 by a 350 watt electric motor C. The rotary valve determines, based on rotation of the drive shaft 5, in which one of the right and left connection tubes 6, 7 the high pressure fluid should be conducted, and thereby whether the piston 8 is moved out of the cylinder 9 or moved into the cylinder 9. The rotary valve simultaneously opens a passage in the other one of the right and left connection tubes 6, 7 between the steering unit and the reservoir for return of fluid to the reservoir. The steering system comprises three pressure relief valves 10, 11, 12, and two anti-cavitation valves 13, 14. The system-pump and corresponding 1500 watt motor A, and optionally also the steering unit B with the 350 watt motor could be combined into one single power pack housed in one single housing. In fact, the entire steering system may be combined into one single unit formed by a housing which houses all the system components and optionally also a reservoir for the steering fluid. This may facilitate the assembly procedure.

The electric motor C receives, in normal operation, a steering signal indicating a relatively small rotation of the rotary valve and rotary meter. The signal may be generated e.g. based on movement of a joystick or a steering wheel which operates an electrical sensor. In fail-operation, the electric motor C receives a signal indicating a relatively large rotation of the rotary valve and meter to operate the rotary meter as a pump. To indicate a shift between the two modes of operation, the system may comprise a sensor which is adapted to indicate a failure of the system-pump, e.g. a pressure sensor.

### EXAMPLE

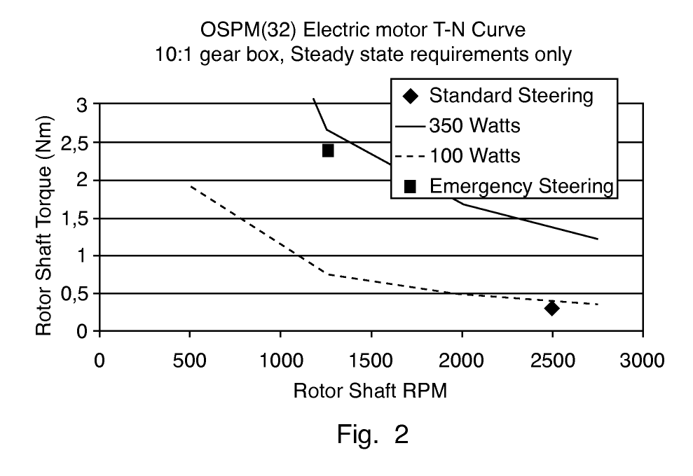

The following example illustrates a steering system for a fork-lift truck. FIG. 2 illustrates an electric motor T-N curve for the fork-lift truck and the following design calculations illustrate further details of the steering system for the fork-lift truck. The steering system is designed for a vehicle which is steered by a steering wheel via a hydraulic steering actuator operating on front wheels of the vehicle.

In this steering system, the steering unit comprises a rotary meter and a rotary valve rotated on a common shaft. The steering unit is referred to as a OSP which is a commercially available steering unit from Sauer-Danfoss A/S, c.f. www. Sauer-danfoss.com. The electric motor could be a standard commercially available electric motor.

| | | | |
|---|---|---|---|
| Displacement = | 32 | cc/rev | cc/rev: cubic centimeter |
| | | | displacement/revolution |
| Motor's Gear Ratio = | 10 | to 1 | 10 rounds of the motor |
| | | | equals one round of the |
| | | | rotary meter |
| Max Required Flow = | 8 | Lpm | lpm: liters per minute |
| Std Torque required = | 3 | Nm | Steering wheel torque |
| Emergency Req'd Flow = | 4 | Lpm | |

| | | |
|---|---|---|
| Emergency Torque required = | 24 | Nm (taken from table below and |
| | | assuming no more than 30 bar |
| | | is required) |

| | | | OSP | Motor | |
|---|---|---|---|---|---|
| | Motor | OSP | Torque | Torque | Power |
| | RPM | RPM | (Nm) | (Nm) | (W) |
| Normal Steering: | 2500 | 250 | 3 | 0.3 | 78,5398 |
| Emergency Steering: | 1250 | 125 | 24 | 2.4 | 314,159 |
| | 500 | 50 | 66.84508 | 6.68451 | 350 |
| | 1250 | 125 | 26.73803 | 2.6738 | 350 |
| | 2000 | 200 | 16.71127 | 1.67113 | 350 |
| | 2750 | 275 | 12.15365 | 1.21537 | 350 |
| | 500 | 50 | 19.09859 | 1.90986 | 100 |
| | 1250 | 125 | 7.639437 | 0.76394 | 100 |
| | 2000 | 200 | 4.774648 | 0.47746 | 100 |
| | 2750 | 275 | 3.472471 | 0.34725 | 100 |

Under normal operation where the system-pump supplies an adequate fluid flow at the required pressure, the maximum torque on the steering wheel will not exceed 2 Nm. If the fluid flow from the system-pump fails or if it is too small, the steering unit functions as a manual steering pump. Manual steering can only be used for a limited control of the vehicle if a sudden drop of pressure from the system-pump occurs. The table below shows the manual steering pressure Pm for all sizes of Sauer-Danfoss steering units type OSPM at a steering wheel torque of 80 Nm. The values apply only if the suction condition on the steering unit reservoir connection is adequate.

OSPM

| | | 32 | 40 | 50 | 63 | 80 | 100 |
|---|---|---|---|---|---|---|---|
| Pₘ | bar | 100 | 90 | 80 | 60 | 50 | 40 |

While the present invention has been illustrated and described with respect to a particular embodiment thereof, it should be appreciated by those of ordinary skill in the art that various modifications to this invention may be made without departing from the spirit and scope of the present invention.

What is claimed is:

1. A steering system comprising a system-pump, a steering actuator, a rotary valve, a rotary meter, and a motor, the system-pump being arranged to provide a flow of a fluid to the steering actuator via the rotary valve and via the rotary meter, and the motor being arranged to provide rotation of the rotary valve and the rotary meter, wherein the motor is dimensioned to operate the rotary meter as a pump for pumping a flow of the fluid to the steering actuator if the system-pump fails.

2. The steering system according to claim 1, wherein the rotary valve and the rotary meter are combined in a steering unit in which both the rotary valve and the rotary meter are operated by one common rotary shaft.

3. The steering system according to claim 1, wherein the motor forms part of the combined steering unit.

4. The steering system according to claim 1, wherein the motor is controlled by a control system comprising user input means by which a user may provide a steering input, the control system being adapted to operate the motor to rotate the rotary meter and the rotary valve to provide a fluid flow to the steering actuator which corresponds to the received steering input.

5. The A steering system according to claim 1, comprising a gear between the motor and at least one of the rotary valve and rotary meter.

6. The steering system according to claim 1, further comprising a check- valve allowing a fluid flow between the system-pump and the rotary meter and preventing a flow in an opposite direction between the rotary meter and the system-pump.

7. The steering system according to claim 1, wherein the system pump is located before the rotary valve and the rotary valve is located before the rotary meter when considered in a flow direction from a reservoir containing the fluid and the steering actuator.

8. The steering system according to claim 1, wherein the motor is a variable RPM electric motor.

9. The steering system according to claim 1, wherein the motor is adapted to rotate the rotary meter at a maximum RPM, at which RPM the rotary meter provides a fluid flow which is at least 50 pct of a maximum capacity of the system-pump.

10. The steering system according to claim 1, wherein the steering actuator acts on a rotary element and the motor is adapted to provide a torque in the range of 30-60 pct of the torque which can be delivered by the steering actuator on the rotary element.

11. A method of operating a steering system in a fail situation, the steering system comprising a system-pump, a steering actuator, a rotary valve, a rotary meter, and a motor, the method comprising:
arranging the system-pump to provide a flow of a fluid to the steering actuator via the rotary valve and via the rotary meter,
arranging the motor to provide rotation of the rotary valve and the rotary meter, and
operating the rotary meter as a pump for pumping a flow of the fluid to the steering actuator by use of the motor in case the system-pump fails.

12. A vehicle with a steering system comprising a system-pump, a steering actuator, a rotary valve, a rotary meter, and a motor, the system-pump being arranged to provide a flow of a fluid to the steering actuator via the rotary valve and via the rotary meter, and the motor being arranged to provide rotation of the rotary valve and the rotary meter, wherein the motor is dimensioned to operate the rotary meter as a pump for pumping a flow of the fluid to the steering actuator if the system-pump fails.

13. The vehicle according to claim 12, being steered by rotation of a steering element which is rotatable by a steering-torque provided by the steering actuator, the motor being capable of delivering a motor-torque in a range of 30-60 of the steering-torque.

14. The vehicle according to claim 12, comprising two independent electrical systems, one providing power to the system-pump and one providing power to the motor.
